(19) United States
(12) Patent Application Publication
(10) Pub. No.: US 2007/0240627 A1
(43) Pub. Date: Oct. 18, 2007

(54) Fluid lever indicator protection sleeve

(76) Inventor: Mark J. Summer, Frankfort, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/594,580

(22) Filed: Nov. 8, 2006

Related U.S. Application Data
(60) Provisional application No. 60/792,730, filed on Apr. 18, 2006.

(51) Int. Cl. G01F 23/00

(52) U.S. Cl. 116/227

(57) ABSTRACT

A fluid level indicator or hydrometer is provided that includes an optical tube and a protective sleeve or jacket. The optical tube is highly polished and includes a site glass integrally connected to a distal cone by an intermediate extension shaft. The protective sleeve or jacket surrounds at least the intermediate extension shaft.

### RELATED APPLICATIONS

This application relates to and claims priority benefits from U.S. Provisional Patent Application No. 60/792,730 entitled “Hydrometer/Fluid Level Indicator Protection Sleeve,” filed Apr. 18, 2006, which is hereby incorporated by reference in its entirety.

### FIELD OF THE INVENTION

Embodiments of the present invention generally relate to a hydrometer or fluid level indicator, and more particularly to a protection sleeve for a hydrometer or fluid level indicator.

### BACKGROUND OF THE INVENTION

Conventional hydrometers are typically used to determine a charge state of a battery. For example, a hydrometer may be positioned within a lead acid battery when the battery is being manufactured. The specific gravity of the battery acid indicates the charge of the battery. A combined level indicator and hydrometer is described in U.S. Pat. No. 4,240,282, which is hereby incorporated by reference in its entirety.

FIG. 1 illustrates an isometric view of a conventional battery hydrometer 10. The hydrometer 10 includes an end cap 12 or plug that may be secured into or onto a battery (not shown). The cap 12 includes a generally cylindrical wall 14 that defines an inner chamber 16. The cylindrical wall 14 includes a plurality of outwardly extending ribs 17 configured to sealingly engage a corresponding opening within a battery or vessel.

A clear optical tube 18 is secured within, and extends outwardly from, the inner chamber 16. The clear optical tube 18 is a light transmissive tube or rod that is formed of a light transmitting material such as acrylic, glass, styrene, or other such material. The optical tube 18 is typically elongated so that it may be mounted in a wall of a battery or fluid vessel, or in the fluid cap of a battery with an upper end exposed and a lower end projecting downwardly to a minimum desired level of liquid within the battery or fluid vessel.

The clear optical tube 18 includes a site glass 20 within the end cap 12. The site glass 20 is integrally connected to an intermediate extension 22, which, in turn, is integrally connected to a distal cone 24. The site glass 20 is configured to be external to the battery or fluid vessel to which the hydrometer 10 is secured. The distal cone 24 is configured to be submerged in liquid contained within the battery or fluid vessel.

Light enters the site glass 20 and travels along the length of the intermediate extension 22. The light then passes from the intermediate extension 22 to the distal cone 24, where the light is then deflected and returns back out the site glass 20. The deflection of the light back to the site glass 20 makes the site glass 20 appear clear and bright.

The outer surface of the optical tube 18 is highly polished in order to ensure that light properly deflects through the optical tube 18. The clear, polished surface of the optical tube 18 ensures that light that enters the top of the hydrometer 10 does not escape the optical tube 18. As long as the site glass 20 is exposed to light, the remainder of the hydrometer 10, including the distal cone 24, may be positioned within a dark enclosure (such as the interior of a battery). When the polish is compromised, light typically diffuses from the outer diameter of the optical tube 18 instead of returning to the site glass 20.

Disposing the hydrometer into a harsh environment, such as a flooded lead acid battery, may compromise the polish of the hydrometer 10. Materials within a battery may leach from the battery and produce a dark “scum” that covers, or otherwise floats on, the surface of the battery acid. The production of scum may be exacerbated depending on the battery materials used. For example, some battery manufacturers use the least expensive components. Some of these components may leach oils and particulates. Scum may result from lead sulfates when the polarity of a battery changes.

Additionally, separators in the battery are made from a process involving oils. Separators are typically made of a plastic material that separates the positive and negative plates to prevent the separators from shorting. Oils are evacuated at the end of the process in order to create pores in the separator. Sometimes, not all of the oils are evacuated at the end of the process, thereby causing scum to form.

As the battery is charged, the battery acid experiences turbulence, which causes the scum to splash onto the outer surface of the optical tube 18. Additionally, during battery charging, gas is formed. As a result, bubbles float to the surface of the battery acid. As the bubbles pop, the scum floating on the surface of the battery acid is upwardly propelled onto the optical tube 18, thereby deteriorating the polished surface of the optical tube 18. The scum, combined with the resulting heat from battery charging, may imbed onto the optical tube 18, thereby compromising the polish of the optical tube 18. As a result, a dark layer covers the optical tube 18 that hinders light from reaching the site glass 20.

Thus, a need exists for a hydrometer that protects an optical tube from losing its polish. A need exists for a system and method of ensuring that scum does not contact an optical tube of a hydrometer.

### SUMMARY OF THE INVENTION

Certain embodiments of the present invention provide a fluid level indicator or hydrometer that includes a highly polished optical tube and a protective sleeve. The highly polished optical tube includes a site glass integrally connected to a distal cone by an intermediate extension shaft. The distal cone is configured to be submerged in a fluid, such as battery acid contained within a battery. The highly polished optical tube may be formed from acrylic, glass, styrene, or the like.

The protective sleeve surrounds at least a portion of the highly polished optical tube. For example, the protective sleeve may surround an outer circumference of the intermediate extension shaft. The protective sleeve is configured to protect the highly polished optical tube from being contacted by impurities. The protective sleeve may be formed from polypropylene, or the like. A gap may be defined between the protective sleeve and the highly polished optical tube.

### DESCRIPTION OF SEVERAL VIEWS OF THE DRAWINGS

FIG. 1 illustrates an isometric view of a conventional battery hydrometer.

FIG. 2 illustrates an isometric view of a hydrometer according to an embodiment of the present invention.

FIG. 3 illustrates a bottom plan view of a hydrometer according to an embodiment of the present invention.

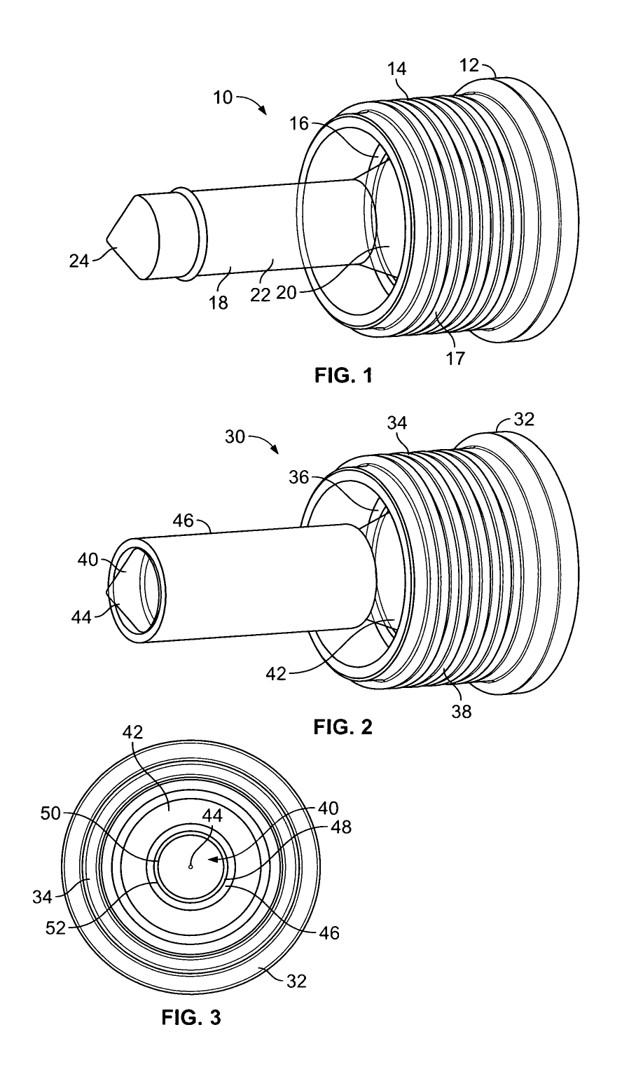

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

FIG. 2 illustrates an isometric view of a hydrometer 30 according to an embodiment of the present invention. The hydrometer 30 includes an end cap 32 or plug that may be removably secured into or onto a battery (not shown). The cap 32 includes a generally cylindrical wall 34 that defines an inner chamber 36. The cylindrical wall 34 includes a plurality of outwardly extending ribs 38 configured to sealingly engage a corresponding opening within a battery or vessel.

A clear optical tube 40 is secured within, and extends outwardly from, the inner chamber 36. The clear optical tube 40 is a light transmissive tube or rod that is formed of a light transmitting material such as acrylic, glass, styrene, or other such materials. The optical tube 40 is typically elongated so that it may be mounted in a wall of a battery or fluid vessel, or in the fluid cap of a battery with an upper end exposed and a lower end projecting downwardly to a minimum desired level of liquid within the battery or fluid vessel.

The clear optical tube 40 includes a site glass 42 within the cap 32. The site glass 42 is integrally connected to an intermediate extension (hidden from view), which, in turn, is integrally connected to a distal cone 44. The site glass 42 is configured to be external to the battery or fluid vessel to which the hydrometer 30 is secured. The distal cone 44 is configured to be submerged in liquid contained within the battery or fluid vessel. The distal cone 44 is configured to be submerged underneath the surface of the fluid, such as battery acid, below any scum that may float on the surface of the fluid.

A protective sleeve or jacket 46 is positioned around the optical tube 40. The protective sleeve 46 surrounds most, if not all, of the optical tube 40, including the intermediate section (hence the reason why the intermediate section is hidden from view). The protective sleeve 46 protects the optical tube 40 from being contacted by scum.

The protective sleeve or jacket 46 may be formed of an acid resistant material, such as polypropylene, PVC shrink wrap, or other such materials. The protective sleeve 46 may be press fit onto the optical tube 40, such that an air gap (shown in FIG. 3) exists between an outer surface of the optical tube 40 and an inner surface of the protective sleeve 46. Optionally, the protective sleeve 46 may be overmolded onto the optical tube 40. In general, the protective sleeve 46 does not combine or adhere to the optical tube 40, thereby ensuring that the optical tube 40 maintains its polish.

As mentioned above, the distal cone 44 is submerged within the fluid, underneath the surface of the fluid. As such, the distal cone 44 is below any scum that may form on the fluid surface. A distal portion of the sleeve 46 may also be submerged underneath the surface of the fluid. Thus, scum is prevented from contacting the optical tube 40 due to the fact that the distal cone 44 is below the scum, and the entire length of the intermediate section of the optical tube 40 is protected by the sleeve 46 (and a portion of the intermediate section may also be below the scum). While FIG. 2 shows the distal cone 44 outwardly extending from the sleeve 46, the sleeve 46 may optionally surround the outer lateral surfaces of the distal cone 44.

FIG. 3 illustrates a bottom plan view of the hydrometer 30 according to an embodiment of the present invention. The protective sleeve 46 surrounds the optical tube 40 such that a gap 48, such as an air gap or vacuum, is disposed between an outer surface 50 of the optical tube 40 and an inner surface 52 of the protective sleeve 46. The gap 48 provides a barrier between the protective sleeve 46 and the optical tube 40. Thus, the gap 48 prevents the protective sleeve 46 from adversely affecting the polish of the optical tube 40. In a press-fit application, a snap fit feature may be provided in a non-critical area to enable assembly. For example, the protective sleeve 46 may include a ridge (not shown) located at an upper end that snapably engages a reciprocal groove formed proximate a union of the intermediate section (hidden from view) and the site glass 42. Optionally, an upper end of the protective sleeve may snapably engage a portion of the end cap 32.

The size of the gap 48 shown in FIG. 3 is merely for illustrative purposes. A minimum amount of separation is to be provided between the protective sleeve 46 and the optical tube 40. The size of the gap 48 is configured to minimize migration of fluid between the protective sleeve 46 and the optical tube 40.

In an over-molded assembly, very little, if any, gap may be provided between the protective sleeve 46 and the optical tube 40. The existence and size of the gap 46 depends on whether the sleeve 46 affects the polish of the optical tube 40. If, for example, the protective sleeve 46 does not affect the polish of the optical tube 40, then the hydrometer may not even need a gap 48.

Referring to FIGS. 2 and 3, the protective sleeve or jacket 46 prevents contaminants from adhering to the clear optical tube 40. Thus, the optical tube 40 remains highly polished and its optical capabilities are, therefore, maintained. The protective sleeve 46 protects the optical tube 40 from any scum that may splash onto the hydrometer 30. The protective sleeve 46 prevents the scum from contacting the highly polished tube 40. Overall, the hydrometer 30 having the protective jacket 46 protects the optical tube 40 within a harsh environment.

Thus, embodiments of the present invention provide a hydrometer that protects an optical tube from losing its polish. Embodiments of the present invention ensure that that scum does not contact an optical tube of a hydrometer.

While various spatial terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A fluid level indicator comprising:
an optical tube having a site glass integrally connected to a distal cone by an intermediate extension shaft, said optical tube being highly polished; and
a protective sleeve surrounding at least said intermediate extension shaft.

2. The fluid level indicator of claim 1, wherein a gap is defined between said protective sleeve and said intermediate shaft.

3. The fluid level indicator of claim 1, wherein said optical tube is formed from one of acrylic, glass, and styrene.

4. The fluid level indicator of claim 1, wherein said protective sleeve is formed from polypropylene.

5. The fluid level indicator of claim 1, wherein said protective sleeve is press fit onto said optical tube.

6. The fluid level indicator of claim 1, wherein said protective sleeve is overmolded to said optical tube.

7. The fluid level indicator of claim 1, further comprising an end cap having an inner chamber, wherein said optical tube is secured within, and extends from, said inner chamber.

8. A hydrometer configured to determine a charge state of a battery, the hydrometer comprising:
a highly polished optical tube having a site glass integrally connected to a distal cone by an intermediate extension shaft, said distal cone being configured to be submerged in battery acid contained within the battery; and
a protective sleeve surrounding at least a portion of said highly polished optical tube, said protective sleeve configured to protect said at least a portion of said highly polished optical tube from being contacted by impurities within the battery.

9. The hydrometer of claim 8, wherein said protective sleeve surrounds an outer circumference of said intermediate extension shaft.

10. The hydrometer of claim 8, wherein a gap is defined between said protective sleeve and said at least a portion of said highly polished optical tube.

11. The hydrometer of claim 8, wherein said highly polished optical tube is formed from one of acrylic, glass, and styrene.

12. The f hydrometer of claim 8, wherein said protective sleeve is formed from polypropylene.

13. The hydrometer of claim 8, wherein said protective sleeve is press fit onto said highly polished optical tube.

14. The hydrometer of claim 8, wherein said protective sleeve is overmolded to said highly polished optical tube.

15. The hydrometer of claim 8, further comprising an end cap having an inner chamber, wherein said highly polished optical tube is secured within, and extends from, said inner chamber.

16. A fluid level indicator configured to determine a charge state of a battery, the fluid level indicator comprising:
a highly polished optical tube having a site glass integrally connected to a distal cone by an intermediate extension shaft, said distal cone being configured to be submerged in battery acid contained within the battery, said highly polished optical tube being formed from one of acrylic, glass, and styrene; and
a protective sleeve surrounding at least a portion of said highly polished optical tube, said protective sleeve configured to protect said at least a portion of said highly polished optical tube from being contacted by impurities within the battery, said protective sleeve is formed from polypropylene, wherein a gap is defined between said protective sleeve and said at least a portion of said highly polished optical tube.

17. The fluid level indicator of claim 16, wherein said protective sleeve surrounds an outer circumference of said intermediate extension shaft.

18. The fluid level indicator of claim 16, wherein said protective sleeve is press fit onto said highly polished optical tube.

19. The fluid level indicator of claim 16, wherein said protective sleeve is overmolded to said highly polished optical tube.

20. The fluid level indicator of claim 16, further comprising an end cap having an inner chamber, wherein said highly polished optical tube is secured within, and extends from, said inner chamber.
